(19) United States
(12) Patent Application Publication
(10) Pub. No.: US 2005/0023974 A1
(43) Pub. Date: Feb. 3, 2005

(54) Protected organic electronic devices and methods for making the same

(75) Inventors: Anna Chwang, Princeton, NJ (US); Michael Hack, Lambertville, NJ (US)

Correspondence Address: MAYER, FORTKORT & WILLIAMS, PC, 251 NORTH AVENUE WEST, 2ND FLOOR, WESTFIELD, NJ, 07090, US

(73) Assignee: Universal Display Corporation

(21) Appl. No.: 10/633,364

(22) Filed: Aug. 1, 2003

(51) Int. Cl. H01J 1/62

(52) U.S. Cl. 313/512; 313/511

(57) ABSTRACT

An organic light emitting device structure is provided, which comprises: (a) a substrate; (b) a first electrode disposed over the substrate; (c) a polymeric layer comprising a conductive polymer disposed over the first electrode; (d) an organic layer consisting essentially of small molecule material disposed over and in direct contact with said polymeric layer; (e) a second electrode disposed over the organic layer; and (f) a thin film encapsulation region disposed over the second electrode. An organic light emitting device is also provided, which comprises: (a) a polymer layer comprising a hole injecting conductive polymer and (b) a small molecule layer comprising an emissive small molecule material. In certain embodiments, the small molecule layer further comprises a small molecule hole injection layer.

### FIELD OF THE INVENTION

The present invention relates to organic light emitting diode devices which are protected from environmental elements such as moisture and oxygen and which display enhanced durability and reliability.

### BACKGROUND OF THE INVENTION

Organic light emitting diodes (OLEDs) are becoming increasingly important from an economic standpoint. For example, OLEDs are potential candidates for a wide variety of virtual- and direct-view type displays, such as lap-top computers, televisions, digital watches, telephones, pagers, cellular telephones, calculators and the like. Unlike inorganic semiconductor light emitting devices, organic light emitting devices are generally simple and are relatively easy and inexpensive to fabricate. Also, OLEDs readily lend themselves to applications requiring a wide variety of colors and to applications that concern large-area devices.

In general, two-dimensional OLED arrays for imaging applications are known in the art, and include an OLED region that contains a plurality of pixels arranged in rows and columns. FIG. 1A is a simplified schematic representation (cross-sectional view) of an OLED structure of the prior art. The OLED structure shown includes an OLED stack 15, which in this simplified case includes a single pixel comprising a lower electrode region such as anode region 12, an organic region 14 over the anode region 12, and an upper electrode region such as cathode region 16 over the organic region 14. The OLED stack 15 is disposed on a substrate 10. The OLED stack 15 is protected by a cover 20, which is attached to the substrate 10 via adhesive 25.

Traditionally, light from the organic region 14 is passed downward through the substrate 10. In such a “bottom-emitting” configuration, the substrate 10 and anode 12 are formed of transparent materials. The cathode 16 and cover 20 (i.e., barrier), on the other hand, need not be transparent in this configuration.

Other OLED architectures are also known in the art, including “top-emitting” OLEDs and transparent OLEDs . For top-emitting OLEDs, light from the light emitting region 14 is transmitted upward through cover 20. Hence, the substrate 10 can be formed of opaque material, if desired, while the cover 20 is transparent. In top-emitting configurations based on a design like that illustrated in FIG. 1A, a transparent material is used for the cathode 16, while the anode 12 need not be transparent.

For transparent OLEDs, in which light is emitted out of both the top and bottom of the device, the substrate 10, anode 12, cathode 16 and cover 20 are all transparent.

Structures are also known in which the positions of the anode 12 and cathode 16 in FIG. 1A are reversed as illustrated in FIG. 1B. Such devices are sometimes referred to as “inverted OLEDs.”

OLED structures more complex than the OLED structures found in FIGS. 1A and 1B have been described, such as that illustrated in FIG. 2. For example, an OLED structure is described in U.S. patent application No. 20020182441 to Lamansky et al., which includes a glass substrate 10, ITO anode layer 12, a copper phthalocyanine (CuPc) hole injection layer (HIL) 14hi, a 4,4′-bis[N-(1-naphthyl)-N-phenyl-amino]biphenyl (α-NPD) hole transport layer 14ht, an emissive layer (EML) 14e consisting of 6%-FIrpic doped into a 4,4′-N,N′-dicarbazole-biphenyl (CBP) host, an aluminum(III)bis(2-methyl-8-quinolinato)4-phenylphenolate (BAlq) layer 14et,ei, used to transport and inject electrons into the EML, and an LiF:Al cathode layer 16.

In forming an OLED device, a layer of low work function metal is typically utilized as the cathode to ensure efficient electron injection and low operating voltages. Low work function metals, however, are chemically reactive; exposure to and subsequent reaction with oxygen and moisture can severely limit the lifetime of the devices. Moisture and oxygen are also known to produce other deleterious effects, for instance, reactions with the organic materials themselves. For example, moisture and oxygen are known in the art to increase “dark spots” and pixel shrinkage in connection with OLEDs.

In response to these issues, sensitive OLED components have been encapsulated using a variety of techniques. However, it has been observed that display damage, for instance, in the form of pixel shorting, bubbling or delamination, often attends the formation of such encapsulated OLED device structures. Thus, there is a need for encapsulated device structures that effectively exclude oxygen, moisture, and other harmful species found in the surrounding atmosphere, and at the same time avoid the display damage that has been found to attend the formation of such structures. These and other challenges are addressed by the present invention.

### SUMMARY OF THE INVENTION

The present invention provides encapsulated OLED device structures, in particular flexible thin film encapsulated structures, that effectively exclude oxygen, moisture, and other harmful species found in the surrounding atmosphere, and at the same time avoid the display damage found to be associated with thin film encapsulation. As disclosed herein, the presence of a conductive polymer layer in direct contact with the organic small-molecule region of an OLED device structure that has been provided with a thin film encapsulation region significantly increases product yield by minimizing or eliminating the display damage seen in device structures provided with a thin encapsulation region in the absence of the present invention conductive polymer layer.

An organic light emitting device structure is provided, which comprises: (a) a substrate; (b) a first electrode disposed over the substrate; (c) a polymeric layer comprising a conductive polymer disposed over the first electrode; (d) an organic region consisting essentially of small molecule material disposed over and in direct contact with said polymeric layer; (e) a second electrode disposed over the organic region; and (f) a thin film encapsulation region disposed over the second electrode.

In another aspect of the invention, an organic light emitting device is provided, which comprises: (a) a polymer layer comprising a hole injecting conductive polymer and (b) a small molecule layer comprising an emissive small molecule material. In certain embodiments, the small molecule layer further comprises a small molecule hole injection layer.

These and other aspects, embodiments and advantages of the present invention will become readily apparent to those of ordinary skill in the art upon review of the disclosure to follow.

### BRIEF DESCRIPTION OF THE DRAWINGS

FIGS. 1A and 1B are schematic, cross-sectional views of two typical known OLED structures.

FIG. 2 is a schematic, cross-sectional view of a known OLED structure.

FIG. 3 is a schematic, cross-sectional view of an OLED structure in accordance with an embodiment of the present invention.

FIG. 4 is a schematic, cross-sectional view of an organic region appropriate for use in connection with an embodiment of the present invention.

FIGS. 5-7 are schematic, cross-sectional views of OLED structures in accordance with various embodiments of the present invention.

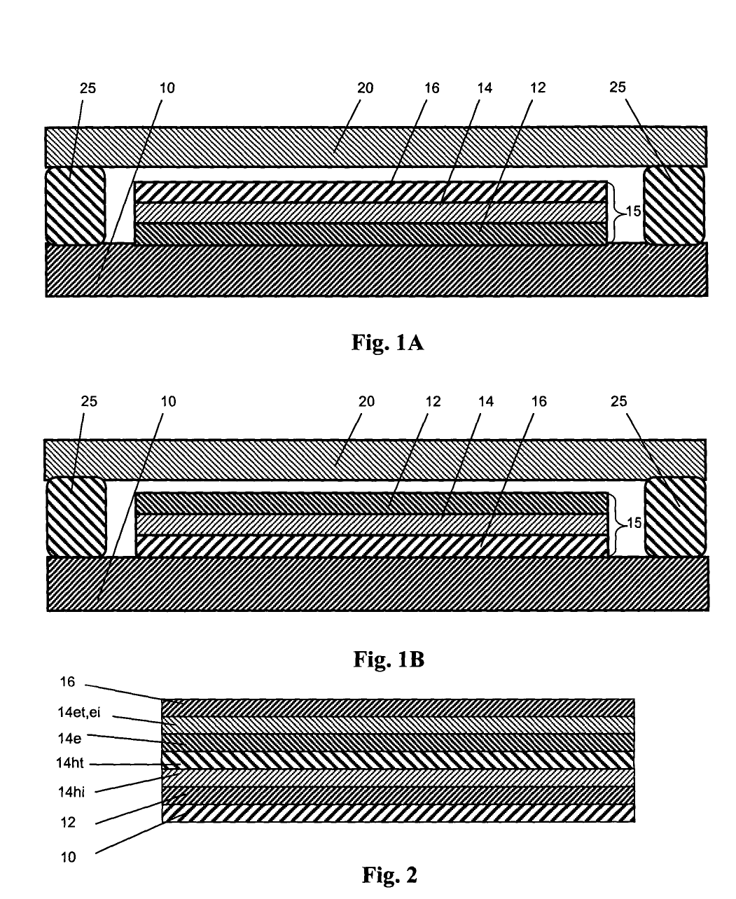

As is typically the case with such figures, the above are simplified schematic representations presented for purposes of illustration only, and the actual structures will differ in numerous respects including the relative scale of the components.

### DETAILED DESCRIPTION OF THE INVENTION

The present invention now will be described more fully hereinafter with reference to the accompanying drawings in which preferred embodiments of the invention are shown. This invention may, however, be embodied in different forms and should not be construed as limited to the embodiments set forth herein.

Sensitive OLED components have been encapsulated by a variety of techniques to avoid the deleterious effects of moisture, oxygen and the like, including the application of multilayer barrier regions such as those described in U.S. patent application 20030085652 to Weaver and in U.S. patent application 20030117068 to Forrest et al. Such multilayer barriers typically comprise an alternating series of layers of planarizing material and layers of high-density material. Multilayer barriers are also described in U.S. Pat. No. 5,757,126 to Harvey, III et al.

The present inventors have found that when an OLED stack (i.e., anode, organic region, cathode) analogous to that described in U.S. patent application No. 20020182441 to Lamansky et al. is used in connection with a multilayer encapsulation scheme like that described in U.S. patent application 20030085652 to Weaver and in U.S. patent application 20030117068 to Forrest et al., for example, to create a flexible display, significant display damage is observed in the form of delamination (appearing as blisters) between the ITO anode and the other OLED layers resulting in unacceptably high levels of pixel shorting when driven. In particular damage has been observed in the form of delamination between the ITO anode and the overlying small molecule hole injection layer (HIL). While not being bound by theory, the present inventors hypothesize that the display damage is produced by interlayer stresses in the OLED stack, specifically stresses between the ITO anode and the overlying organic hole injection layer, which results in delamination of the same. These and other challenges are addressed by the present invention. It is hypothesized that the aforementioned stresses are reduced by the presence of an intervening conductive polymer layer in the present invention.

As used herein, a “layer” of a given material includes a region of that material whose thickness is small compared to both its length and width. Examples of layers include sheets, foils, films, laminations, coatings, and so forth. As used herein, a layer need not be planar, but can be bent, folded or otherwise contoured, for example, to at least partially, or even completely, envelop another component. As used herein, a layer can also include multiple sub-layers. As used herein, a layer can constitute a single region of material, or it can consist of a collection of discrete regions of material (for example, a patterned layer can be provided in the form of a collection of bands).

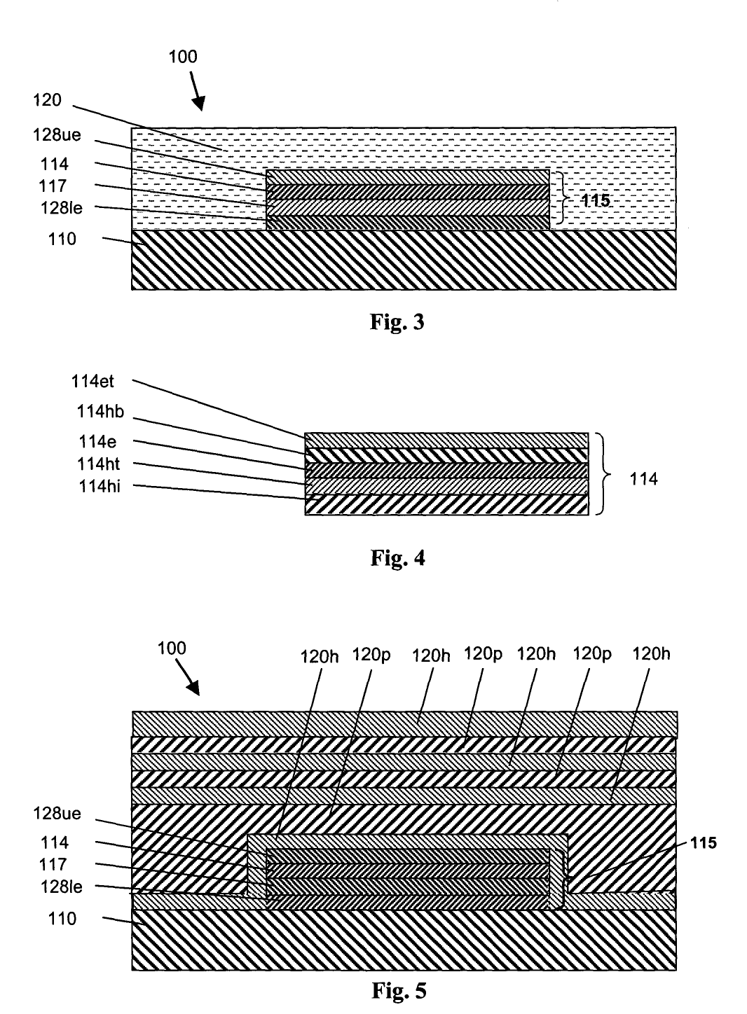

FIG. 3 is a simplified schematic representation (cross-sectional view) of an OLED structure 100 in accordance with an embodiment of the present invention. The OLED structure 100 includes a substrate 110, organic region 114 and two electrodes, i.e., upper electrode 128ue and lower electrode 128le, one of which is an anode and the other of which is a cathode. A polymer layer 117 is disposed between the lower electrode 128le and the organic region 114. An encapsulation region 120 is disposed over the substrate 110 and OLED stack 115, which contains lower electrode 128le, polymer layer 117, organic region 114 and upper electrode 128ue.

Depending on the application, the anode may be a transparent anode or an opaque anode (which can be a reflective in some cases). Opaque anode materials include metals such as gold, chromium, magnesium/silver or other materials known in the art, while transparent anode materials include metal oxides such as indium tin oxide (ITO), zinc tin oxide or other materials known in the art. Similarly, the cathode can be transparent or opaque depending on the application. Opaque cathode materials may include metals such as aluminum, aluminum/lithium, aluminum/lithium fluoride, or other materials is known in the art, while transparent cathode materials may include metal/metal oxide combinations such as Mg—Ag/ITO, Ca/ITO or other materials known in the art.

In an exemplary bottom-emitting embodiment, the lower electrode 128le is a transparent ITO anode, and the upper electrode 128ue is an aluminum/lithium fluoride cathode. By “transparent” is meant that attenuation of radiation as it passes through the region of interest is low, with transmissivities typically greater than 50%, more typically greater than 80%, at the wavelength of interest.

In an exemplary top-emitting embodiment, the upper electrode 128ue is a transparent cathode comprising an ITO layer over a thin reactive metal layer, such as a layer of Ca or Mg—Ag alloy and the lower electrode comprises a layer of ITO over a layer of reflective metal such as Ag, Al, Ni, Cr, etc. By “reflective” is meant that the amount of radiation reflected from a surface is high, with reflectivities typically greater than 50%, more typically greater than 80%, at the wavelength of interest.

In an exemplary transparent OLED embodiment, the lower electrode 128le is a transparent ITO anode, and the upper electrode 128ue is a transparent cathode comprising an ITO layer over a thin reactive metal layer, such as a layer of Ca or Mg—Ag alloy.

The organic region 114 can be provided in a number of configurations, including the following: (a) a configuration comprising a single layer that provides hole transporting, electron transporting and emission functions (i.e., a single layer configuration), (b) a two-layer configuration comprising a hole transport layer and a layer that provides both emission and electron transporting functions (i.e., a single heterostructure configuration), (c) a three-layer configuration comprising a hole transport layer, an emissive layer and an electron transport layer (i.e., a double heterostructure configuration). In each configuration, additional layers may also be present, for example, layers that enhance hole injection or electron injection, or layers that serve to block holes or electrons or excitons. Examples include: (d) a four-layer configuration comprising a hole injection layer, a hole transport layer, an emissive layer, and an electron transport layer, and (e) a five-layer configuration comprising a hole injection layer, a hole transport layer, an emissive layer, a hole blocking layer, and an electron transport layer, and so forth. Several structures for such devices are discussed, for example, in U.S. Pat. No. 5,707,745, the entire disclosure of which is hereby incorporated by reference. Other OLED architecture is also practiced in the art.

In one specific embodiment, which is illustrated in FIG. 4, the organic region is a five-layer stack containing (1) a hole injection layer 114hi, for example, a layer containing an organic metal complex material such as a phthalocyanine compound (e.g., copper phthalocyanine (CuPc)) or a porphyrin-based compound; (2) a hole transport layer 114ht, for example, a layer containing an aromatic amine such as 4,4′-bis-[N-(1-naphthyl)-N-phenyl-amino]-biphenyl (NPD), 4,4′-bis(diphenylamino)-biphenyl (TAD), 4,4′-bis[N-(3-methylpbenyl)-N-phenyl-amino]-biphenyl (TPD), 4,4′-bis-[N-(1-naphthyl)-N-phenyl-amino]-biphenyl (NPD), 4,4′,4″-tris(N,N-diphenyl-amino)-triphenyl amine (ThDATA), or 4,4′,4″-tris[N-(3-methylphenyl)-N-phenyl-amino]-triphenyl amine (MTDATA); (3) an emissive layer 114e, for example, a layer containing 4,4′-N,N′-dicarbazole biphenyl (CBP) and one or more dopants; (4) a hole blocking layer 114hb, for example, a layer containing bis(2-methyl-8-quinolinolate)-(4-hydroxy-biphenylil)-aluminum (BAlq) or bathocupuroin (BCP); and (5) an electron transport layer 114et, for example, a layer containing a metal complex such as a quinoline or benzoquinoline complex, for example, aluminum tris(8-hydroxyquinolate) (Alq₃), tris(4-methyl-8-quinolinolate)aluminum (Almq), or bis(10-hydroxybenzo[h]-quinolinate)beryllium (Bebq).

Referring again to FIG. 3, the polymer region 117 beneficially comprises one or more conductive polymers. Conductive polymers are frequently, but not necessarily, conjugated polymers, by which is meant that the polymer contains alternating single and double carbon-carbon bonds along its backbone. Some examples of conductive polymers include polypyrrole, polyaniline, poly(p-phenylene vinylene), polysulfone, polyacetylene, and polythiophenes, for example, polyethylenedioxythiophenes such as poly(3,4-ethylenedioxythiophene) (PEDOT). A preferred polymer is formed using Baytron® P CH 8000 from Bayer, Industrial Chemicals Division, Pittsburgh, Pa., USA, which is an aqueous dispersion of PEDOT and poly(styrene sulfonate) (PEDOT-PSS). A device having a PEDOT-PSS polymer layer can be provided using a variety of polymer application techniques, for example, spin coating, ink-jet printing, evaporative coating, spraying, flash evaporation, chemical vapor deposition, and so forth.

OLED structures containing PEDOT-PSS polymer layers are known. For example, structures have been described which contain a glass or plastic substrate; an ITO anode; a hole injection layer formed from Baytron® poly(3,4-ethylenedioxythiophene)/poly(styrene sulfonate) (PEDOT-PSS); a hole transport layer, i.e., a dendritic amine such as 1,3,5-tris[4-(diphenylamino)phenyl]-benzene derivatives (TDAPB); an emissive/electron transport layer, i.e., an emissive/electron transport layer containing an aluminum complex such as aluminum tris(8-hydroxyquinolate) (Alq₃); and a metal cathode 16 such as Mg:Ag. By including the PEDOT-PSS hole injection layer, the ITO surface is said to be smoothed, resulting in fewer electrical short circuits and thus fewer malfunctioning devices, while at the same time having low electrical crosstalk in small pixel matrix array displays. See, e.g., Baytron® P CH 8000 Conductive Polymers, Product Information, October 2000.

In the present invention, the substrate region 110 and encapsulating region 120 are selected to, inter alia, restrict transmission of oxygen and water from the outside environment to the organic region 114. Depending on the application, the substrate 110 and encapsulating region 120 can be opaque or transparent. For traditional bottom-emitting OLED structures, the substrate region 110 will be transparent, as least in part, while the encapsulating region 120 can be opaque. For top-emitting OLED structures, the substrate region 110 can be opaque, while the encapsulating region 120 will be transparent, at least in part. For TOLED structures, both the substrate region 110 and the encapsulating region 120 will be transparent, at least in part.

The materials selected for the substrate region 110 will depend upon the application at hand and include semiconductors, metals, metal alloys , ceramics, polymers and composite layers.

For example, semiconductors such as silicon offer good barrier properties to water, oxygen and other harmful species and also provide a substrate upon which electronic circuitry can be built.

Metals also offer excellent barrier properties. Preferred materials include aluminum, gold, nickel, nickel alloys, stainless steel, and indium, as well as other metals known in the art. Where flexibility is desired, metal foils are preferred , for example in flexible OLED structures known in the art that utilize flexible substrate and encapsulation regions 110, 120.

Ceramics also offer low permeability, and they provide transparency as well in some cases.

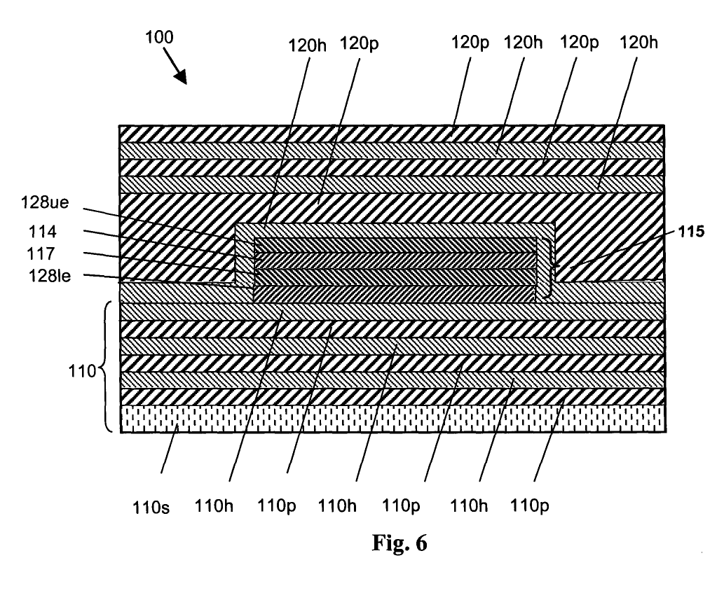

Polymers are often preferred where optical transparency and flexibility are desired. Preferred polymers include polyesters, polyethersulphones, polyimides, polycarbonates and fluorocarbons, with such layers typically being used in connection with composite materials as discussed further below in connection with FIG. 6. Composite materials are advantageous, for example, in that they can provide transparency and flexibility, while also providing good resistance to transmission of chemical species such as water and oxygen.

The OLED structure 100 also includes an encapsulating region 120. As used herein, an “encapsulation region” is a region that is applied over an underlying region (for example, via a coating or deposition process) such that it contacts and adheres to the underlying region. As illustrated in FIG. 3, in some embodiments, the encapsulation region 120 is formed from a single layer of material such as silicon nitride, silicon oxynitride, aluminum oxynitride, or any other inorganic material that is impermeable to water and oxygen, including other high-density materials listed below.

In other embodiments, the encapsulating region 120 is a composite region comprising a series of cooperative barrier layers. Referring now to FIG. 5, an encapsulation region is illustrated, which contains a series of cooperative barrier layers that includes both layers of planarizing material 120p and layers of high-density material 120h. These cooperative barrier layers are preferably provided in an alternating configuration. For example, 1 to 10 pairs of these layers, more preferably 2 to 7 pairs, are used. Thus, arrangements other than that illustrated in FIG. 3 are clearly possible.

By “planarizing material” is meant a material that forms a smooth planar surface upon application, rather than forming a surface that reflects irregular contours of the underlying surface. Preferred planarizing materials include polymers, such as fluorinated polymers, parylenes, cyclotenes and polyacrylates and combinations thereof. Layers of such planarizing materials 120p can be provided using techniques known in the art, for example, by dipping, spin coating, sputtering, evaporative coating, spraying, flash evaporation, chemical vapor deposition and so forth.

By “high-density material” is meant a material with sufficiently close atomic spacing such that diffusion of contaminant and deleterious species, particularly water and oxygen, are hindered. Preferred high-density materials include inorganic materials such as metal oxides, metal nitrides, metal carbides and metal oxynitrides and combinations thereof. Examples of high-density materials include silicon oxides (SiOₓ), including silicon monoxide (SiO) and silicon dioxide (SiO₂), silicon nitrides (typically Si₃N₄), silicon oxynitrides, aluminum oxides (typically Al₂O₃), aluminum oxynitrides, indium-tin oxides (ITO) and zinc indium tin oxides and combinations thereof. Layers of high-density material 120h can be applied using techniques known in the art such as thermal evaporation, sputtering, PECVD methods and electron-beam techniques.

In other embodiments, the substrate 110 is a composite material. For example, referring to FIG. 6, an OLED structure 100 is illustrated which is like that of FIG. 5, except that the substrate 110 comprises a substrate layer 110s and a series cooperative barrier layers. The cooperative barrier layers include both layers of planarizing material 110p and layers of high-density material 110h. Appropriate materials for the layers of planarizing material 110p and layers of high-density material 110h are discussed above. As with the cooperative barrier layers within the encapsulating region 120, the cooperative barrier layers of the substrate 110 are preferably provided in an alternating configuration, with 1 to 10 pairs of these layers, more preferably 2 to 7 pairs being used.

The cooperative barrier layers 110p, 110h are disposed adjacent the substrate layer 110s in the embodiment shown in FIG. 6. As a result, during manufacture, the substrate layer 110s can act as a foundation upon which the cooperative barrier layers 110p, 110h can be laid.

Where flexibility is desired, the substrate layer 110s may comprise paper, fabric, metal foil, flexible glass (available, for example, from Schott Glass Technologies) and/or polymer layers. Flexibility is desirable, for example, in the manufacture of flexible OLEDs and renders the devices formable using web-based, roll-to-roll manufacturing techniques. More preferred flexible substrate layer materials are those that comprise one or more polymer components, including polyesters, polycarbonates, polyethersulphones, polyethylenenaphthalates, polyarylates, polyimides such as Kapton® polyimide film available from DuPont, fluoropolymers such as Aclar® fluoropolymer available from Honeywell, Appear® PNB (polynorbomene) available from BF Goodrich and Arton® available from BF Goodrich., and polyolefins that are capable of providing a strong adhesive bond with other materials. Such polymer components can be supplied, for example, in connection with homopolymers, copolymers and polymer blends. The substrate layer 115 in this instance typically ranges from 75 to 625 microns in thickness.

It is noted that the substrate 110 as illustrated in FIG. 6 can be inverted such that the substrate layer 110s is at the topmost position.

An advantage of the encapsulated OLED structures described herein is that they are effective in protecting sensitive device components from oxygen, moisture and other harmful species in the surrounding atmosphere. These novel encapsulated structures are also advantageous in that it is possible to produce OLED structures that are flexible and conformable to other surfaces, while at the same time avoiding the display damage that has been found to attend the formation of such encapsulated structures.

A getter material (not illustrated) may also be provided with the OLED structures of the present invention. The getter material can be essentially any getter material that reacts readily with reactive gases (including water and oxygen), forming stable low-vapor-pressure chemical compounds so as to remove the reactive gases from the gas phase. The getter material is provided to remove reactive gases such as water and oxygen in the event that they penetrate the sealed package, before these gases have the opportunity to cause damage to the OLED region. Desiccants, which are a class of getter material that remove water, are useful for the practice of the present invention. Getter materials include Group IIA metals and metal oxides, such as calcium metal (Ca), barium metal (Ba), barium oxide (BaO) and calcium oxide (CaO).

As noted above, significant display damage in the form of delaminations/ blisters between an ITO anode and an overlying small-molecule HIL layer, in particular, has been observed by the present inventors in connection with their use in thin-film-encapsulated OLED devices. This display damage is accompanied by unacceptably high levels of shorting during OLED illumination. However, by providing an intervening conductive polymer layer (e.g., a PEDOT-PSS layer), such damage is minimized or eliminated, significantly increasing product yield. While not wishing to be bound by theory, the present inventors hypothesize that the OLED damage seen in thin-film-encapsulated OLED devices without the conductive polymer layer is produced by interlayer stresses that develop between the electrode and an adjacent small-molecule organic region during the formation of the thin film encapsulation region, and that these stresses are reduced by the presence of the conductive polymer layer of the present invention. The following non limiting Examples serve to illustrate the invention.

### EXAMPLE 1

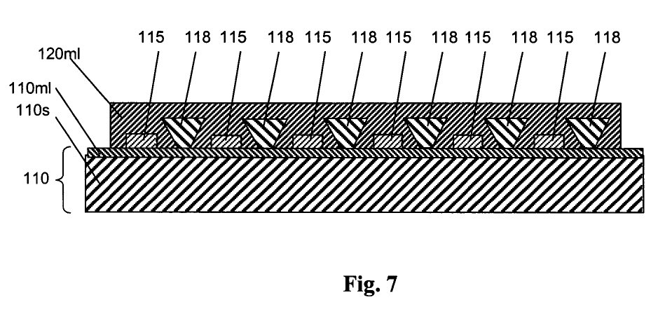

The following describes a process in accordance with the present invention for the formation of a thin film encapsulated OLED display, specifically a flexible OLED which process will now be described with reference to FIG. 7.

The substrate 110 in this example is a flexible substrate consisting of substrate layer 110s and a multilayer barrier stack 110 ml (layers not separately illustrated). The substrate layer 110s in this example is barrier coated polyethylene terephthalate (PET) of thickness 7 mil (178 μm). The multilayer barrier stack 110 ml consists of alternating layers of an organic polymer (i.e., polyacrylate) as a planarizing material and an inorganic dielectric (i.e., aluminum oxide, Al₂O₃) as a high-density material. There are approximately 5 alternating pairs of these materials on the substrate. The first polymer layer planarizes the surface to make it smooth, while subsequent polymer layers serve to decouple any defects in the inorganic dielectric. The inorganic dielectric layers act as the permeation barrier to H₂O and O₂.

Deposited on top of the multilayer barrier stack 110ml is a 150-200 nm thick layer of ITO (not separately illustrated) which is subsequently patterned and used as the anode in the OLED stack 115. After the ITO is patterned, metal contact pads (not separately illustrated), an insulating pixel grid (not separately illustrated), and cathode separating pillars 118 are deposited/defined.

Subsequently, the remainder of the OLED stack 115 is formed. First, a solution of PEDOT-PSS in water (Baytron® P CH 8000) is spin coated onto the display substrate at 4000 rpm for 40 seconds. Baytron® P CH 8000 is nominally conducting and acts as a first hole injection layer (HIL₁) in the OLED. The PEDOT-PSS is wiped off of the metal contact pads so that future contact to the electrodes is not inhibited. The display substrate with the PEDOT-PSS is then placed in a vacuum oven to bake the moisture from the PEDOT-PSS (e.g., at 90° C. for an hour).

After this step, the remainder of the OLED stack 115 is deposited in a vacuum thermal evaporation chamber. Typically the remainder of the OLED consists of the following layers: HIL₂/HTL/EML/BL/ETL/cathode where HIL₂=second hole injection layer, HTL=hole transport layer, EML=emissive layer, BL blocking layer, and ETL=electron transport layer. In this example, the OLED consists of the following layers: CuPc/α-NPD/CBP:dopant/BAlq/Alq₃/LiF/Al. Typical thicknesses of these layers in Å are as follows: 400/300/300/100/400/10/800. These films are sequentially deposited on top of the ITO/(PEDOT-PSS). The CuPc on top of the PEDOT-PSS (note that both are hole injection layers) provides OLED stability, a characteristic needed for commercial viability. Moreover, the use of a thicker CuPc layer, e.g., 400 Å, appears to yield longer OLED lifetime than a thinner CuPc layer, e.g., 100 Å.

After completion of the OLED stack 115, the display is then directly encapsulated by depositing a thin film encapsulation region consisting of a barrier stack 120ml (layers not separately illustrated) on top of the. The first layer of the thin film encapsulation region in this example is the high-density/dielectric layer (e.g., a 1200 Å aluminum oxide layer), which is reactively sputtered onto the display. Then a planarizing layer is formed by depositing monomer (e.g., acrylate monomer) as a liquid (e.g., flash evaporation) and subsequently UV curing the same to form the planarizing (polyacrylate) layer. Typically 4-5 additional pairs of dielectric/polymer layers (e.g., 400 Å aluminum oxide/0.5 μm polyacrylate) are deposited.

Hence, the multilayer, thin film encapsulation region on top of the display is very similar to the multilayer barrier stack on the substrate and serves to protect the OLED from the top. Total thickness of the multilayer encapsulant stack is typically 5-7 μm, the bulk of which consists of the first polymer layer which is targeted to be 4 μm thick (deposited, for example, as four consecutive 1 μm layers) to assist in planarizing the underlying layers.

### EXAMPLE 2

Encapsulated displays were made in accordance with the process described in Example 1, either with or without a PEDOT-PSS layer. All devices were examined and tested approximately one week after manufacture. In the devices without the PEDOT-PSS polymeric layer, pixels were observed to fail within the first few minutes of display illumination, resulting in blisters/delamination. In analogous devices containing the PEDOT-PSS polymeric layer, on the other hand, blisters/delamination were not observed, and such pixel failure was minimal or non-existent. Indeed, pixels in devices containing the polymeric layer of the invention were observed to continue functioning after 100 hours or more of illumination.

The results show that by providing an intervening conductive polymer layer as disclosed herein (e.g., a PEDOT-PSS layer), between the anode and the overlying organic small-molecule layer in a device having a thin film encapsulation region, display damage associated with the formation of encapsulated organic displays is minimized or eliminated, thereby significantly increasing product yield.

Although the present invention has been described with respect to several exemplary embodiments, there are many other variations of the above-described embodiments that will be apparent to those of ordinary skill in the art. It is understood that these variations are within the teachings of the present invention, and that the invention is to be limited only by the claims appended hereto.

1. An organic light emitting device structure comprising:
a substrate;
a first electrode disposed over said substrate;
a polymeric layer comprising a conductive polymer disposed over said first electrode;
an organic region consisting essentially of small molecule material disposed over and in direct contact with said polymeric layer;
a second electrode disposed over said organic region; and,
a thin film encapsulation region disposed over said second electrode.

2. The organic electmnic device structure of claim 1 wherein said organic electronic device structure is a flexible OLED device structure.

3. The organic electronic device structure of claim 1 wherein said first electrode is an anode and said second electrode is a cathode.

4. The organic electronic device structure of claim 3 wherein said anode comprises an indium-tin oxide layer.

5. The organic electronic device structure of claim 3 wherein said cathode comprises a lithium fluoride layer and an aluminum layer.

6. The organic light emitting device structure of claim 1 wherein said substrate is selected from a metal layer, a metal alloy layer, a semiconductor layer, a glass layer, a ceramic layer, and a polymer layer.

7. The organic light emitting device structure of claim 1 wherein said substrate is a composite material that comprises: (a) a polymer substrate layer, (b) a plurality of high-density layers, and (c) a plurality of planarizing layers, which high-density layers may be the same or different from each other, and which planarizing layers may be the same or different from each other.

8. The organic light emitting device structure of claim 7 wherein said substrate comprises at least three pairs of alternating high-density and planarizing layers.

9. The organic light emitting device structure of claim 1 wherein said thin film encapsulation region is a multilayer encapsulation region.

10. The organic light emitting device structure of claim 9 wherein the multilayer encapsulation region comprises a plurality of high-density layers and a plurality of planarizing layers, which high-density layers may be the same or different from each other, and which planzing layers may be the same or different from each other.

11. The organic light emitting device structure of claim 10 wherein said multilayer encapsulation region comprises at least three pairs of alternating high-density and planarizing layers.

12. The organic light emitting device structure of claim 1 wherein said small molecule material comprises a small molecule emissive material.

13. The organic light emitting device structure of claim 12 wherein said small molecule material further comprises a small molecule hole injecting material.

14. The organic light emitting device structure of claim 13 wherein said small molecule hole injecting material comprises an organic metal complex.

15. The organic light emitting device structure of claim 1 wherein said organic region is a multilayer region including an emissive layer.

16. The organic light emitting device structure of claim 15 wherein said multilayer region further comprises a small molecule hole injection layer.

17. The organic light emitting device structure of claim 16 wherein said hole injection layer consists essentially of an organic metal complex.

18. The organic light emitting device structure of claim 17 wherein said an organic metal complex is copper phthalocyanine.

19. The organic light emitting device structure of claim 1, wherein said organic region is a multilayer region comprising a hole injection layer a hole transport layer disposed over said hole injection layer, an emissive layer disposed over said hole transport layer, a Socking layer disposed over said emissive layer, and an electron transport layer disposed over said blocking layer.

20. The organic light emitting device structure of claim 1 wherein said conductive polymer is selected from polypyrroles, polyanilines, poly(p-phenylene vinylenes), polysulfones, polyacetylenes, and polythiophenes.

21. The organic light emitting device structure of claim 20, wherein said polymeric layer comprises poly(3,4-ethylenedioxythiophene).

22. The organic light emitting device structure of claim 21, wherein said polymeric layer further comprises a poly(styrene sulfonate).

23. The organic light emitting device structure of claim 1, wherein said polymeric layer is spin coated.

24. The organic light emitting device structure of claim 1, wherein said polymeric layer is ink jet printed.

25. The organic light emitting device structure of claim 1 wherein said first electrode is an anode comprising indium-tin oxide; wherein said polymeric layer comprises poly(3,4-thylenedioxythiophene); wherein said organic region includes a hole injection layer adjacent to said polymeric layer, said hole injection layer consisting essentially of copper phthalocyanine; wherein said second electrode is a cathode; and wherein said encapsulation region comprises a plurality of high-density layers and a plurality of planarizing layers, which high-density layers may be the same or different from each other and which planarizing layers may be the same or different from each other.

26. An organic light emitting device comprising (a) a polymer layer comprising a hole injecting conductive polymer and (b) a small molecule layer comprising a small molecule emissive material.

27. The organic light emitting device of claim 26 wherein said small molecule layer further comprises a small molecule hole injecting material.

28. The organic light emitting device of claim 27 wherein said small molecule hole injecting material comprises an organic metal complex.

29. The organic light emitting device of claim 28 wherein said organic metal complex is copper phthalocyanine.

30. The organic light emitting device of claim 26 wherein said conductive polymer is selected from polypyrroles, polyanilines, poly(p-phenylene vinylenes), polysulfones, polyacetylenes, and polythiophenes

31. The organic light emitting device of claim 26 wherein said polymer layer comprises poly(3,4-ethylenedioxythiophene).

32. The organic light emitting device of claim 31 wherein said polymer layer further comprises poly(styrene sulfonate).
